(19) United States
(12) Patent Application Publication
(10) Pub. No.: US 2004/0248071 A1
(43) Pub. Date: Dec. 9, 2004

(54) System and method for autonomous training

(76) Inventors: Serguei Bedziouk, Ile des Soeurs (CA); Laurent Chardon, Scarborough (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 10/455,709

(22) Filed: Jun. 6, 2003

(51) Int. Cl. G09B 9/00; A63B 69/00

(52) U.S. Cl. 434/247; 434/219

(57) ABSTRACT

A system and method are provided for autonomously training an operator to manipulate an object, such as a robotics device in space or simulated in-space conditions. Input parameters are gathered during a presented training exercise and used to provide feedback to the operator relating to the results of the training exercise. The feedback can be presented as graphical and textual data, and can be shown in varying degrees of detail. The system can advantageously determine a factor having a high correlation between the result of the training exercise and the operator's level of skill relating to that determined factor, which helps the operator to define the cause of the training result. Training is preferably presented to the operator based on baseline skill levels associated with a stored operator's profile. A system and method are also provided to monitor and mitigate operator critical skill degradation.

### FIELD OF THE INVENTION

The present invention relates generally to autonomous skill-based training without the presence of an instructor. More particularly, the present invention relates to autonomous training of astronauts on-board a space station for robotics tasks encountered during space flight.

### BACKGROUND OF THE INVENTION

Autonomous training has the advantage of providing training without the need for an instructor. Autonomous training is particularly well-suited to training related to space exploration and space flight, in which cases the presence of a suitable trainer is impractical if not impossible. Space exploration is a challenging and rewarding endeavour that involves significant risks and is quite costly. On the International Space Station (ISS), one of the most complex and dangerous pieces of equipment is the Space Station Remote Manipulator System (SSRMS) also known as Canadarm2™. The safety of the flight crew as well as of the equipment on the flight depends largely on crew performance while manipulating the SSRMS, including the performance of a mobile service system robotics operator (MRO), herein referred to simply as an operator. Over a period of time spent on-board a space station, operator skills may degrade significantly. A number of factors are known to play a role in operator skills degradation, such as: psychological and physiological stress of the space flight; pre-flight training program fidelity and adequacy; lack of practice; and individual differences.

Astronauts having been on board the MIR space station for an extended period of time have commented that the training for long, duration missions should be primarily skills-based. Crewmembers should be trained in basic skills that can be applied to several different tasks rather than on task specific activities as much as possible. Onboard training covers a wide spectrum of activities to maintain or develop a crewmember's knowledge and skills required to perform tasks in flight. Some of these tasks involve operation of robotics, such as the manual controlled robot-manipulator Canadarm2™, in order to manipulate a particular object or achieve a particular result. Although crewmembers are highly educated and receive a great deal of pre-flight training, a need still exists for real-time support and just-in-time training, each ideally being offered in-flight or alternatively in simulated in-flight conditions.

There are some solutions that have been explored in order to provide suitable training. U.S. Pat. No. 4,843,566 to Gordon et al. entitled, “Robot Motion Control System”, relates generally to the use of a personal computer for controlling a mechanical manipulator, but in a laboratory environment to teach robotics to individuals not skilled in this art. There is no suggestion of use of this system in space or in simulated space conditions. Similarly, U.S. Pat. No. 4,988,981 to Zimmerman et al. entitled, “Computer Data Entry and Manipulation Apparatus and Method”, relates to an apparatus for generating control signals for the manipulation of virtual objects in a computer system according to gestures and positions of an operator's hand or other body part. It appears that such a system may be used for on-screen manipulation in the field of robotics. However, Zimmerman et al.'s teachings appear to be at a general level and are not contemplated for use in space or in simulated space conditions. The teachings also appear only to relate to the collection of data relating to the movement of a manipulated virtual object, and the training cannot be customized based on the identity of the user or learner.

U.S. Pat. No. 5,110,294 to Brand et al. entitled, “Device For Ground-Based Simulation of Operations of a Manipulator Usable in Space by Means of a Model of a Space Vehicle”, relates to three dimensional simulation for manipulators which can be used in space. This system however is restricted to ground-based simulation rather than on-board, in-orbit simulation or in simulated space conditions. The system also appears only to relate to the collection of data relating to the movement of a manipulated virtual object, and the training cannot be customized based on the identity of the user or learner.

Some solutions have been proposed that provide an on-board simulator which is essentially a replica of a ground simulator. For instance, U.S. Pat. No. 5,224,861 to Glass et al. entitled, “Training Device Onboard Instruction Station”, relates to an onboard instruction station for a training device which provides a human/computer interface that is designed to support an optimum instructor's scan pattern of the training scenario. Glass et al. does not include the application of this technology to the on-board training of robotics, nor does it specifically contemplate the use of such a system for use by an astronaut in space or in simulated space conditions. Glass et al. also appears only to relate to the collection of data relating to the movement of a manipulated virtual object, and the training cannot be customized based on the identity of the user or learner.

Another solution using a docking simulator has been described in “A Psychodiagnostic and Training System” by Salnitski et al., XII Conference on Space Biology and Aerospace Medicine (Jun. 10-14, 2002, Moscow, Russia, C. 302. C. 580), as well as in “Operators Proficiency of Space Specific Operations During Isolation Study” by Salnitski et al., 53^{rd} International Astronautical Congress, Houston, Tex., USA, 10-19 Oct. 2002. The simulator described in the above documents was used on-board the MIR space station for proficiency training of Soyuz spaceship docking operation. The docking simulator records and collects data relating to the position, orientation and relative velocities of a space ship controlled by an astronaut with respect to the space station. However, this data is recorded in isolation from any other data related to the astronaut inputs such as hand controller deflection. The analysis of the collected data is performed at a ground station, so the astronaut does not directly receive feedback relating to the training exercises. Furthermore, the simulator is not equipped to provide customized training based on the identity of a user.

Such a class of simulator has the following drawbacks: it cannot present to the operator and to the ground an automated data processing and evaluation of the training and results of performance analysis at different levels of detail; it cannot provide the operator with analysis of the factors contributing to the success or failure of the operator in the training exercise; it is not capable of mitigating and compensating for these factors in order to decrease the probability of operator error; it cannot identify degraded operator critical skills aboard a space station; it cannot evaluate the level of critical skills degradation; it cannot focus training on identified degraded critical skills; and it cannot provide the training session until the required skill level is reached.

Moreover, these prior art solutions require much more training time and do not provide any feedback to the trainee on training efficacy. Also, the prior art solutions are more complicated and expensive, require significant crew time for assembly and set-up, and take up valuable real estate on-board.

It is, therefore, desirable to provide an improved and autonomous training arrangement.

### SUMMARY OF THE INVENTION

It is an object of the present invention to obviate or mitigate at least one disadvantage of previous training arrangements.

In a first aspect, the present invention provides a system for training an operator to manipulate an object including an object controller, a display means, and a general purpose computer having a processor and a memory. The system includes a training module for providing a training exercise to the operator in which a simulated object displayed on the display means is to be manipulated by the operator by means of the object controller. The system also includes an analysis module for receiving object controller parameters and simulated object parameters, such parameters being gathered during the training exercise. The system further includes a presentation module for presenting feedback relating to results of the training exercise to the operator, the feedback being based on both the object controller parameters and the simulated object parameters.

In another aspect, the present invention provides an autonomous training system for training an operator to manipulate an object. The system includes a general purpose computer having a processor, an object controller and a display means. The system also includes a memory means having stored therein baseline skill levels, user profiles, and critical skill training exercises. A training module is included for providing a training exercise to the operator in which a simulated object displayed on the display means is to be manipulated by the operator by means of the object controller, the training exercise being selected from the stored critical skill training exercises based on an operator profile retrieved from the stored user profiles. An analysis module is included for evaluating, using the processor, the operator's success in the customized training program in comparison to a baseline skill level retrieved from the stored baseline skill levels based on the operator profile. A presentation module is included for presenting feedback relating to results of the training exercise to the operator, and for determining whether further training is needed to achieve a desired skill level stored in the memory.

In further aspect, there is provided a method of preventing operator performance degradation for an operator of an object controller. The method includes the following steps: providing a training exercise to an operator to improve a degraded operator critical skill; monitoring recovery dynamics for the degraded operator critical skill during the provided training exercise; and providing feedback based on the operator's training exercise results.

In a yet further aspect, there is provided a system for training a learner to accomplish a task including a feedback means, and a general purpose computer having a processor and a memory. The system includes: a training module for providing a training exercise to the learner in which a task to be performed is presented to the learner via the feedback means; an analysis module for receiving parameters relating to the performed task, such parameters being gathered during the training exercise; a presentation module for presenting feedback via the feedback means relating to results of the training exercise to the operator, the feedback being based on the gathered task-related parameters.

In a still further aspect, there is provided a method of automatically establishing a baseline level for a learner training to perform a task. The method includes the following steps: providing a set of training exercises to the learner; monitoring skill acquisition dynamics for the learner during the provided training exercises; and automatically storing a baseline level in a computer memory after the learner reaches a plateau level based on predetermined criteria.

The principles and methods developed can be used in any application where there is a need to mitigate against operator skill or performance degradation, or to effect skill or performance acquisition and where critical tasks can be identified. This performance monitoring and training method could be used in commercial industries such as mining, drilling and nuclear plants. It is particularly useful for training in remote locations where the presence of an instructor would be impractical or impossible. Not only will this method identify degraded critical skills, but it will also provide feedback on operator proficiency and progress in a time and cost-efficient manner. Specific examples in the Armed Forces environment include pilot training, ship operations, and tank operations.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a block diagram of a system according to an embodiment of the present invention;

FIG. 2 is a block diagram of a system according to another embodiment of the present invention;

FIG. 3 illustrates an example of feedback according to an embodiment of the present invention that is presented to an operator relating to a training exercise and having a second degree of detail;

FIG. 4 illustrates an example of feedback according to an embodiment of the present invention that is presented to an operator relating to a training exercise and having a third degree of detail; and

FIG. 5 is a flowchart illustrating a method according to an embodiment of the present invention.

### DETAILED DESCRIPTION

Generally, the present invention provides a system and method for training an operator to manipulate an object, such as a robotics device in space or simulated in-space conditions. Object controller parameters and simulated object parameters are gathered during a presented training exercise and used to provide feedback to the operator relating to the results of the training exercise. The feedback can be presented as graphical and textual data, and can be shown in varying degrees of detail. The system can advantageously determine a factor having a high correlation with the result of the training exercise and display data relating to that determined factor, which helps the operator to define the cause of the training result. Training is preferably presented to the operator based on baseline skill levels associated with a stored operator's profile. A system and method are also provided to monitor and mitigate operator critical skill degradation.

A system according to an aspect of the present invention preferably comprises a general purpose (laptop) computer. Such a computer is lightweight, takes up little space and power, and is easily accommodated on-board a space vessel or space station. The computer comprises a processor and a memory. In the memory is stored software to perform the steps of the method. An external memory may also be provided and connected to the general purpose computer. An object controller, such as a hand controller, is in communication with the general purpose computer. The system is preferably a stand alone system that has a power supply that is independent of the space station power supply.

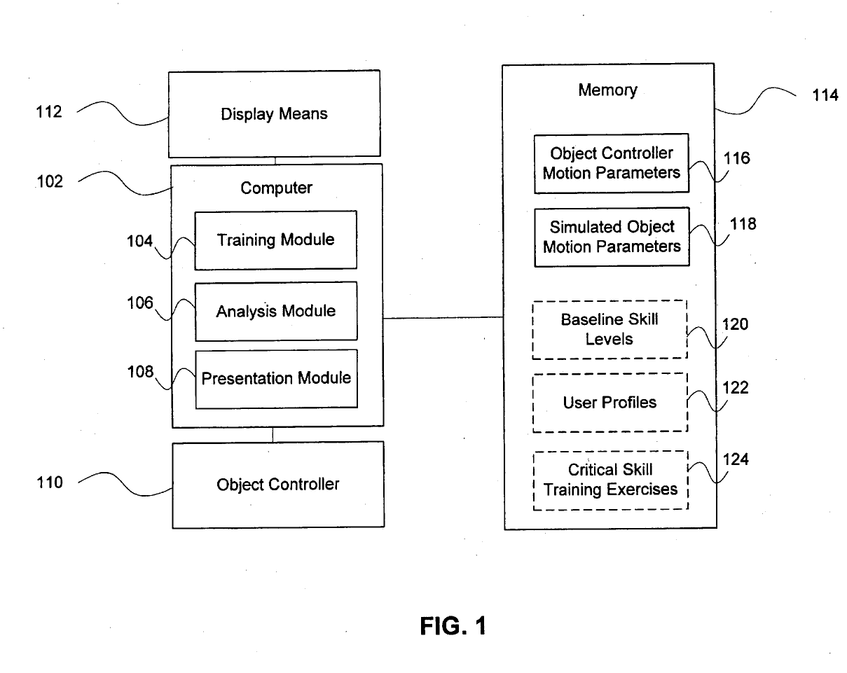

FIG. 1 is a block diagram of a system according to an embodiment of the present invention. FIG. 1 shows a general purpose, computer 102 that is in communication with both an object controller 110 and a display means 112, as well as with a memory 114. The computer 102 comprises a processor (not shown in FIG. 1) that performs the necessary processing relating to the use of training module 104, analysis module 106, and presentation module 108. The modules are preferably implemented in software that can be executed on the computer 102. These modules are shown as being stored in the computer 102, but can alternatively be stored in any memory or storage location, as long as the computer 102 is able to access them and perform functions relating to them.

The training module 104 provides a training exercise to the operator. Such a training exercise can be stored in the memory 114 as part of critical skill training exercises 124. The training exercise includes a simulated object displayed on the display means 112, the simulated object representing an object to be manipulated by the operator by means of the object controller 110. Such an object can be, for example, a robotics device to be used in space or in simulated in-space conditions, such as the manual controlled robot-manipulator Canadarm2. While participating in a training exercise, the operator moves the object controller 110 in order to control the behaviour and movement of the simulated object in the training exercise. The simulated object can include a plurality of simulated objects, and movement of the object controller can affect the motion of each of those simulated objects.

During the training exercise, the computer 102 collects simulated object parameters 116, such as motion parameters, as well as object controller parameters 118, again such as motion parameters, and stores them in the memory 114. The collection of both types of parameters is advantageous with respect to being able to determine the cause of failure or success in the training exercise. Although the simulated object parameters and object controller parameters will be described in the examples below as motion parameters, it is to be understood that these parameters can include any other type of parameter, such as simulation status, elapsed time, temperature sensor measurements, force measuring/feedback mechanism measurement, etc.

The analysis module 106 receives both the simulated object motion parameters 116 as well as the object controller motion parameters 118. The analysis module is able to correlate the received motion parameters in order to provide useful feedback to the operator. In previous systems, typically only simulated object motion parameters were gathered. However, collecting and receiving object controller motion parameters in addition to simulated object motion parameters allows the two types of parameters to be correlated. The collection and receipt of more than one quality performance parameter provides for better and more useful results than what could be obtained with previous systems. The analysis module can prepare data to be presented to the operator, by means of the presentation module 108, that can assist the operator in the training process.

The presentation module 108 presents feedback relating to results of the training exercise to the operator. Such feedback is based on both the object controller motion parameters 116 and the simulated object motion parameters 118. For example, the operator can identify a point in time at which the simulated object motion parameters diverged from the expected or desired motion parameters, and identify the corresponding object controller motion parameters that contributed to the divergence from the desired motion parameters. The desired motion parameters can be included as part of baseline skill levels 120 stored in the memory 114. Further detail will be provided later with respect to particular manners of correlating the motion parameters and presenting feedback to the operator.

An example of a computer that can be used as the general purpose computer 102 is an IBM ThinkPad 760 series laptop computer. The object controller 110 can be any device that controls the motion of the simulated object and from which data relating to the position of the object controller can be gathered by the computer 102 for use with respect to provided training modules or assessments. Examples of a suitable object controller include a rotational hand controller and a translational hand controller, each being known in the art for use with training for manipulation of a robotics device, or simulated robotic manipulation of an object. The display means can be any standard CRT or LCD display, or other suitable display device. The system is preferably operated in space, in order to properly measure an operator's performance in the appropriate environment. Alternatively, the system can be operated in simulated in-space conditions, such as in a vacuum chamber or an environment having neutral buoyancy. This is preferable because of the observation of skill degradation over a period of time in space conditions, which will be described later.

The computer 102 is also in communication with a memory 114, which can be physically housed in the same box as the computer 102. In a presently preferred embodiment, the memory 114 stores baseline skill levels 120, user profiles 122, and critical skill training modules 124. The baseline skill levels 120 are predetermined levels of skill that should be attained by a user, or that a user will be measured or evaluated against. The user profiles 122 can be individual user profiles, or user profiles relating to a particular class or category of user. Each user profile contains information relating to desired baseline skill levels for that user. The critical skill training modules 124 are training modules used for evaluation, refresher training and/or just-in-time training. The selection of the training modules 124 is performed in accordance with baseline skill levels 120 identified in user profiles 122.

For example, when launching a training session, the operator can be presented with a login screen, in which the user selects his/her name from a user list. When the user's name is selected, the system can retrieve the operator's user profile from the stored user profiles 122. In accordance with the retrieved user profile, the system retrieves the associated operator's baseline skill levels from the stored baseline skill levels 120. Also, a set of critical skill training modules can be retrieved from the stored critical skill training modules 124, the selection being based on the operator's user profile.

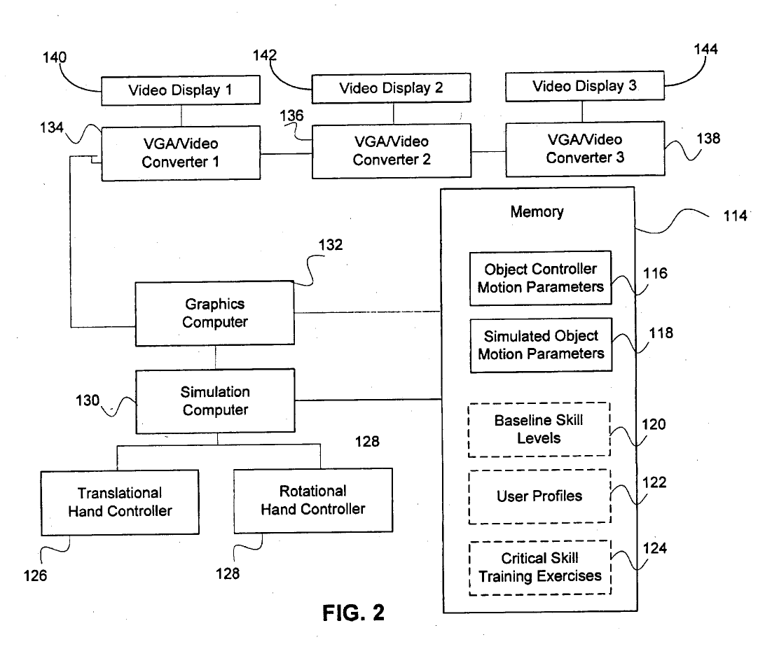

FIG. 2 is a block diagram of a system according to another embodiment of the present invention. This embodiment has the same memory 114, storing the object controller motion parameters 116 and simulated object motion parameters 118, and preferably storing baseline skill levels 120, user profiles 122 and critical skill training modules 124 as in FIG. 1. The difference is found in the equipment used as object controller, computer and display means.

The embodiment in FIG. 2 has two object controllers: a translational hand controller 126, and a rotational hand controller 128. These two controllers are particularly well suited to accept inputs for training exercises having to do with remote robotic manipulation. Of course, any number or type of object controller can alternatively be used.

The embodiment in FIG. 2 also employs a dual-laptop configuration. A simulation computer 130 has a central processing unit (CPU), or processor, dedicated to running the simulation or training exercise. A graphics computer 132 has a CPU, or processor, dedicated to running the graphics for the training. The simulation computer 130 and the graphics computer 132 can consist of two separate processors housed in the same laptop. The two computers can be connected together by a suitable connection means, such as a 10 Base-T Ethernet connection. The computers were tested running the Solaris, Linux and Windows 95 operating systems, with the Windows environment providing the best results.

The display means in the embodiment of FIG. 2 employs hardware splitting of the graphics display. Three video converters 134, 136 and 138, such as a VGANideo converter, are used to drive three separate video displays 140, 142 and 144, such as LCD displays, respectively. It was found that using three laptops as opposed to a single laptop with video splitting can improve the display rate by a factor of three.

As is well known in the art, systems and methods according to embodiments of the present invention can additionally use mental imagery to integrate recovered critical skills with routine elements into the entire performance training program. This can provide enhanced learning tools to the operator. The most typical example of such mental imagery is simply to display to the operator on the display means a demonstrated procedure relating to a particular task to be performed, so that the operator is able to visualize the steps involved.

Embodiments of the present invention provide advantageous benefits with respect to the analysis of training exercise results and the display of such results to an operator, or to a ground control station. With motion parameters relating to both the object controller and the simulated object being collected, better and more useful results are provided to the operator since there are now two quality performance parameters being measured and analyzed. The analysis module 106 and the presentation module 108 of a system according to an embodiment of the present invention co-operate to provide such results to the operator.

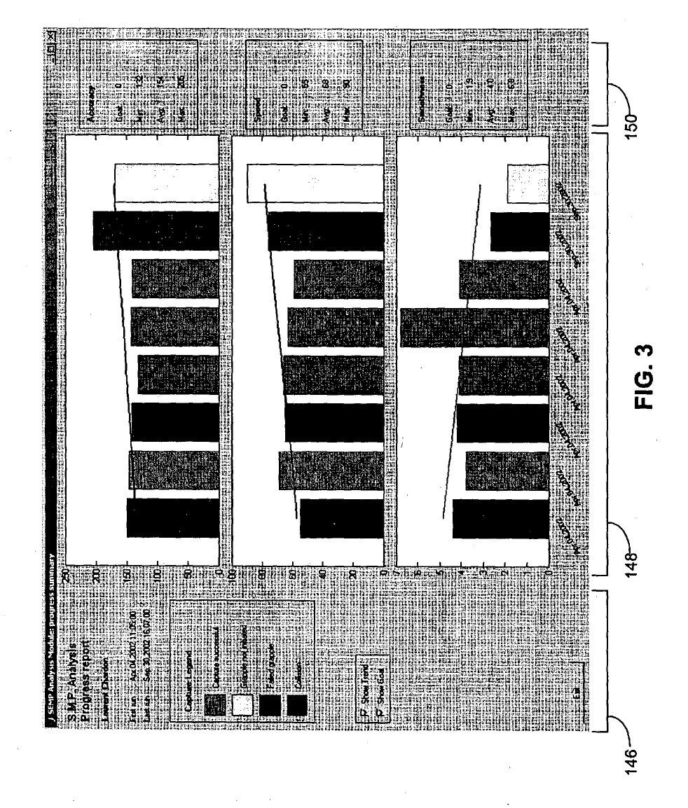

FIG. 3 illustrates an example of feedback presented to an operator relating to a training exercise. The feedback illustrated in FIG. 3 has a second degree of detail, namely a moderate amount of detail. In the case of FIG. 3, the feedback includes graphical data relating to the object controller motion parameters and the simulated object motion parameters, preferably displayed to the operator via the display means 112. In FIG. 3, three performance criteria, or quality criteria, are displayed: accuracy, speed and smoothness. A baseline or target value, or goal, is preferably displayed for each performance criteria, as well as minimum, maximum and average values for each of the attempts that are displayed. The example in FIG. 3 shows eight attempts, each being identified as having a final result of either: capture successful, grapple not initiated, failed grapple, or collision. The results shown in FIG. 3 can also be used by the operator, or ground crew, for performing trend analysis based on the results of various training exercises. The display shown in FIG. 3 will be described below in to three zones: general information zone 146; central plot zone 148; and details zone 150.

The general information zone 146 the left of the display shown in FIG. 3 shows general information about the tasks and the operator. There are two user selectable checkboxes in this zone. When the operator selects the Show Goal checkbox, a line representing the values established as a baseline for the operator will be displayed. When the operator selects the Show Trend checkbox, a progress line on each plot will be displayed. This line is a fit of the bar plot data. The line will preferably be coloured a first colour, such as green, when the results are improving with time, and a second colour, such as black, when the results are worsening with time.

The central plot zone 148 shows three colour bar plots in this example. The top plot displays the variation of the operator's accuracy factor throughout the various training exercises. The middle plot displays the variation of the operator's speed for task completion throughout the various exercises. The bottom plot displays the variation of the operator's smoothness at the object controller throughout the various exercises. The bars in the plots are preferably coloured according to the result of the payload capture. The following represents an exemplary colour selection: green indicates successful capture; yellow indicates that the graple was not initiated; magenta indicates that the capture was not successful; red indicates a collision with the payload or a collision with an FRGF pin inside an LEE.

The details zone 150, shown on the right of FIG. 3, includes for each of the three plots, a box with numbers indicating the minimum, average and maximum values of the measured quantity throughout the sessions. A “goal” number is also displayed, which indicates the operator's established baseline.

Although a plurality of bar graphs are shown in FIG. 3, any other suitable graphical means, such as pie charts, can be used to convey information relating to the results of any number of training exercises. There are many other performance criteria that can be measured, analyzed and displayed such as, for example: position, rate, velocity, orientation, deflection, oscillation, smoothness, accuracy and speed. Each of these performance criteria can be measured as part of the object controller motion parameters or of the simulated object motion parameters.

An advantageous aspect of the present invention includes the ability to provide feedback with varying levels of detail to the operator. As mentioned above, the example in FIG. 3 illustrates an example of feedback having a moderate amount of detail. An example of feedback having a small amount of detail, or a first degree of detail, is a basic training recommendation. This training recommendation can be implemented, for example, as a simple dialog box that tells the operator whether or not he/she was successful in achieving the baseline skill level required for that particular operator.

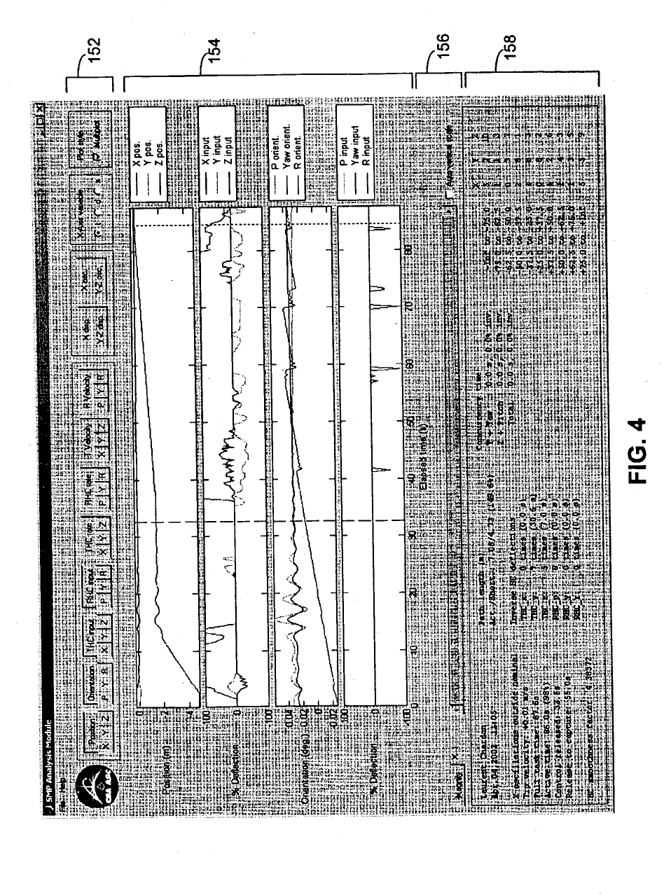

FIG. 4 illustrates an example of feedback presented to an operator relating to a training exercise having a different degree of detail according to an embodiment of the present invention. In FIG. 4, an example is shown where a large amount of detail, or a third degree of detail, is provided. A graphical representation such as that illustrated in FIG. 4 can be presented directly to the operator upon request of such an amount of detail. It can alternatively be made available to the operator in response to the operator selecting, or “clicking on”, an aspect of a graphical representation of feedback presented to the operator having a smaller degree of detail. For instance, if the operator selects one of the bars in FIG. 3 representing one of the training exercise attempts, the operator can then be brought to a feedback report, or representation, similar in nature to that illustrated in FIG. 4.

The graphical display in FIG. 4 can be divided into four zones: top zone 152, or button area; plots zone 154; magnification zone 156; and text zone 158. The top zone 152 preferably includes several groups of buttons that the operator can click on. These buttons allow the operator to select the plots that will be displayed, the independent variable that will be used throughout the plots, and the number of plots displayed. The information contained in this zone is preferably static, i.e. it does not change—it only reflects the user choices. Variables can be selected or deselected by clicking on the appropriate toggle buttons in the plot type toolbar.

The buttons on the top row in the top zone 152 control three axes at once. Selecting one of these buttons will add a plot with three colour-coded lines. The buttons on the bottom row in the top zone 152 control each axes (X, Y, Z or Pitch, Yaw, Roll) individually and selecting one of these buttons will add a plot with only one line. In a preferred embodiment, the independent variable is selected by default to be time, measured in seconds. The user can switch the independent variable between time (t), position (x) and average displacement (d) using the X-Axis variable box. By default, four plots preferably appear on the screen when the user starts the session analysis module. Selecting an additional plot from the plot type toolbar will add a new plot to the display. This behaviour can be changed by un-checking the Multiplot option at the right of the top zone 152. When Multiplot is not selected, only one plot will be shown at a time. When the user selects another plot type, the new plot replaces the existing one. Also, deselecting a selected button can have the effect of removing the corresponding plot from the display.

The plots zone 154 is a display zone, preferably where most of the relevant information is presented graphically. Plots occupy the centre of this zone. To the right of the plots are preferably provided legends that indicate which quantities are shown in each plot. To the left of the plots are preferably provided the Y-axis labels together with their associated units. Within the plots area there are also preferably provided vertical dotted lines, as can be seen in FIG. 4. These dotted lines relate to particular events in the training exercise. In the particular example shown in FIG. 4, the first dotted line from the left, with the large dashes, shows a point at which the operator released an HTV control system. The dotted line that is on the right side, close to the limit of the plots, shows a point at which the operator initiated a free-flyer capture.

The magnification zone 156 includes a set of tools that enables the operator to magnify part of the plots displayed in the plots zone 154 and to navigate the magnified plots. The magnification zone 156 also preferably includes an indication of the present level of magnification, which can have a default factor of 1 (full size). When the Magnify button is pressed, the user can drag a mouse pointer over a region of a plot. A bounding box will help the user visualize the region that will be magnified. When the user releases the mouse button, the plot will be updated to show only the region within the X-axis limits of the bounding box. The X-axis scale is changed to reflect the new boundaries of a magnified plot. The scroll bar under the plots becomes active and can be used to scroll through the entire data set with a constant window size. The magnification factor is updated and shows the current magnification factor. Clicking again on Magnify will deselect this mode, in which case the magnification factor will return to 1.

On the right of the scroll bar in the magnification zone 156, there is a checkbox that allows for an automatic vertical scale. In a preferred embodiment, the vertical scale remains constant by default while under Magnify mode. The user can override this default behaviour by selecting the Auto vertical scale. The vertical scale will then be calculated to show the most detail for the region that is currently displayed. The automatic vertical scale will change the limits of the vertical axis when the scroll bar is used.

The text zone 158 displays text that summarizes information on the task completed during the training exercise. The operator cannot interact with the contents of the text zone, which do not change during analysis or presentation of training exercise results.

The text display shown in the example in FIG. 4 is divided in four columns, and will be described in relation to those columns. The first column shows user information, date and time of the performance and a performance summary. The performance summary indicates if the user completed the capture successfully, what the tip velocity was when the snares were closing, how long the user took to complete the task and how long the user took to capture once the control system was disabled. The “active time”, i.e. the time during which the user was producing hand controller inputs, is also indicated. The last line of the first column shows the smoothness factor, an indicator of the success of the user to be progressive and smooth during his hand controller inputs.

The second column in the text zone 158 shows the path length of the SSRMS tip. Both the actual path commanded by the user and the theoretical best path length towards the target are shown, as well as their ratio in percent. In the bottom part of the second column, inverse hand controller deflections are shown for each axis. In the third column, concurrent hand-controller inputs in Y+Yaw and Z+Pitch are shown. If some of the concurrency includes an inverse deflection, the percentage of inverse deflection in the total concurrency time is shown. The fourth column shows a break-down of the data that was used to calculate the smoothness factor of column 1.

Feedback such as shown in the examples of FIG. 3 and FIG. 4 provides useful information to the operator, or alternatively to a central control station, such as a ground control station. The system can use correlation between simulated object motion parameters and object controller motion parameters in order to determine the cause of failure or success in a training exercise. This determination, and the underlying data, can advantageously be presented to the operator in the presented feedback. Any one of a number of motion parameters or quality performance parameters can be singled out as a particular cause of failure or success.

The system of the present invention advantageously includes a factor analysis module for determining which criterion, or criteria, is most informative for determining performance goals. The factor analysis module determines which factor has a high correlation with the result of the training exercise. In other words, the factor analysis module determines which criteria or quality performance parameter has a high impact on the overall result of the training exercise. The results of the determination of the factor analysis module are preferably used in order to determine which factors will be plotted as graphical data in the feedback presented to the operator by the presentation module. For instance, the factors of time and accuracy can be particularly relevant to the overall result of the training exercise in the initial stages of space flight; however, other factors can have a greater impact on the overall result when considering long periods of time in space flight.

Also, because of the skill degradation over time, which also varies from user to user, different factors may be more relevant, or have a higher correlation, at different stages of space flight. A system according to an embodiment of the present invention advantageously takes these variations into account and can regularly recalculate the correlations between individual factors and the overall result of the training exercise in order to provide up-to-date and relevant information to the operator by means of the feedback provided in the plots and other data preferably shown on the display means. As such, even the appearance of certain parameters on the feedback plots will provide an indication to the operator as to which factors are positively and negatively affecting the overall result of the training exercise.

The ability to conduct on-board training on a space station, such as the International Space Station, will be used by the expedition crew astronauts and cosmonauts to maintain operational readiness and task execution performance. It is assumed that the crew has received the necessary skills and knowledge prior to launch but that a need to maintain proficiency, provide a refresher and be able to accommodate new or contingency tasks exists. Such different types and frequency of training are desired since there is currently not enough research regarding psychomotor and cognitive skill decay in a microgravity environment to support a definitive frequency assigument that maintains a desired level of readiness.

Onboard Training (OBT) comprises training that occurs after arrival at the International Space Station (ISS) and includes Proficiency, Refresher, and Just-In-Time training. These types of training are defined as follows.

Proficiency training comprises training scheduled on a recurring basis throughout the training process to ensure the maintenance and retention of previously acquired knowledge, skills, or attitudes with respect to specific tasks. The maximum time span between training sessions or between training and operations is defined as the currency requirement. As a general rule, on-orbit proficiency training time span requirements may be less stringent than that used pre-flight. On-orbit proficiency may be affected by the zero G environment, thereby influencing the currency requirements

Refresher training comprises training conducted on an as-needed basis at the request of an individual crewmember, This training is typically used to “review” and stimulate individual crewmembers' skills, knowledge, and understanding of ISS systems, payloads, and vehicles.

Just-in-time training (JIT) comprises training that is conducted on-orbit immediately prior to specific task execution. Previously untrained material is a distinguishing characteristic of JIT. JIT training will generally be used for unanticipated tasks, such as unanticipated hardware maintenance tasks and crew health care emergencies. JIT is coordinated through the mission planners.

The robotics on-board training (ROBT) program can use existing International Space Station (ISS) standard flight laptops and utilize as much equipment that is already onboard as possible.

The following assumptions are made: elements of the program can be developed and tested on a commercial equivalent of the flight hardware or software; data loading into elements can be accomplished via floppy drive, CD-ROM drive, or file transfer through Ethernet or other similar connectivity; data from the program elements can be dumped to a suitable transfer/storage device; power for program elements will be able to be provided in all ISS modules; bandwidth necessary for training conduct will be available to the limits of the ISS communication system; ISS RBEV graphics can be used as visual feedback

Elements of the ROBT program advantageously comply with all applicable International Space Station Program environmental standards/requirements. The primary operating systems for software elements is preferably a standard operating system, such as Solaris (UNIX), Windows 95, or any other equivalent standard operating system. The ROBT program preferably includes an online help, including functional descriptions of all robotic systems, displays, and controls needed by the operator to achieve all ROBT objectives without the need for paper procedures.

The ROBT program preferably enables the operator to achieve at least one of the following objectives:

a. Maintain system specific robotics operator certification

b. Provide an on-board environment for individual proficiency and refresher training.

c. Support Just-In-Time operations

d. Rehearse planned robotics operations

e. Develop contingency robotics operations

f. Modify training programs based on operational validation

An advantageous feature of a system according to an embodiment of the present invention is the ability to modify training programs based on operational validation. In order to provide this feature, the system contains software that performs the following steps or functions: Receive modified training scenarios; Identify deltas between current and past training content; Access to reference material and SMEs; Conduct training and confirm new certification.

The principles and methods developed can be used in any applications where there is a need to mitigate against operator performance degradation and where critical tasks can be identified. This performance monitoring and training method could be used in commercial industries such as mining, drilling and nuclear plants. Not only will this method identify degraded critical skills, but it will also provide feedback on operator proficiency and progress in a time and cost-efficient manner. Specific examples in the Armed Forces environment include pilot training, ship operations, and tank operations.

Previous methods of proficiency training did not have critical skill on-board monitoring stage. They used the same training program for all individuals based on general requirements for proficiency training. However, skills degradation dynamics are very different for different human operators both with respect to the rate of skill degradation and type of skills liable to degrade. According to an embodiment of the present invention, a list of critical skills can be identified. This list can be based on expert opinion and experimental results. These skills will be monitored on board of the space station, or in any other environment where an operator operates an object controller.

Previous methods of proficiency training used the mean performance standards for all operators, not taking into account the differences in style and learning among the operators. As a result, they prompt an each operator to reach the same artificial standard. According to embodiments of the present invention, an individual profile is used for each operator. This profile can be generated after the operator's completion of on-ground training. This baseline profile, which is preferably different for each operator, is used for comparison with current operator skill level on board of a space station, or at any time during orbit. Based on the comparison with that profile, it is possible to identify degraded operator critical skills and their level of degradation for a particular operator.

With respect to critical skills recovery dynamics, previous methods relied on instructor opinion or operator self-evaluation for monitoring the degradation of recovery dynamics, which could be far from accurate. In having objective criteria for skills evaluation and a baseline for comparison (individual profiles), using a system or method according to embodiments of the present invention allows accurate and objective measurement of the dynamics of skill recovery.

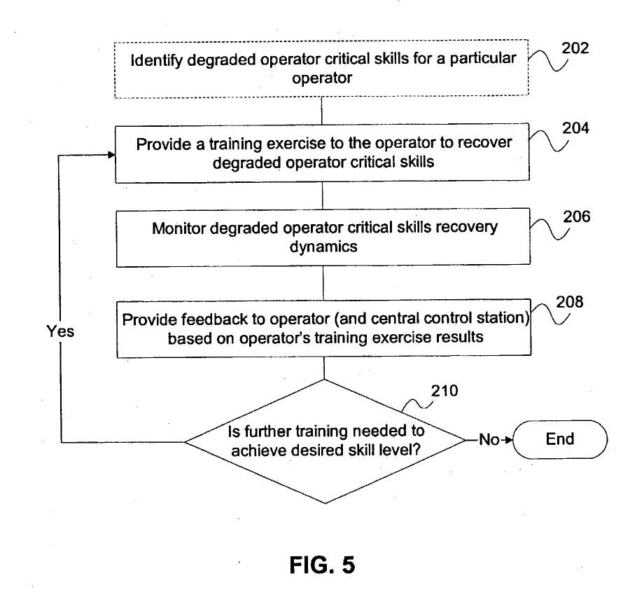

FIG. 5 is a flowchart illustrating a method according to an embodiment of the present invention. This flowchart illustrates a method of preventing operator performance degradation for an operator of an object controller. The object controller can control an object such as a vehicle, a vessel, or portion thereof, or any other device or system having an object that can be controlled, such as a robotics device on a space station.

Referring to FIG. 5, in optional step 202, degraded operator critical skills are identified for a particular operator. The degradation of an operator's skill can be identified by comparing a previously observed operator critical skill level to a baseline skill level. If the previously observed operator skill level is below the baseline skill level, operator critical skill degradation is identified. This identification can preferably include identifying the level of degradation. The information relating to baseline critical skill levels for a particular operator is stored in a memory. The memory can be on-board the vehicle. Alternatively, the memory can be at a remote location, such as at the central control station, while still being accessible from the vehicle, such as by wireless transmission or other suitable manners known to those of skill in the art.

In step 204, a training session is provided to the operator to recover degraded operator critical skills. In step 206, the recovery dynamics of degraded operator critical skills are monitored during the training exercise(s) of the training session. In step 208, feedback is, provided to the operator and to a central control station based on operator's training exercise results. This feedback can include information relating to the recovery dynamics. The feedback can also include information relating to the operator's success in achieving a desired skill level, or any of the other feedback information discussed in detail earlier.

In step 210, a determination is made as to whether further training is needed to achieve a desired skill level. This is preferably accomplished by comparing the operator's success in the critical skills training exercise to the baseline skill level for the identified critical skill. If the operator has not achieved the baseline skill level, it is determined that further training is needed and the method returns to step 204. Preferably, the training exercise is provided to the operator until a desired performance level is reached. Otherwise, the method comes to completion with a determination that the baseline skill level has been achieved.

The use of individual profiles and objective skill dynamics measurement permits embodiments of the present invention to provide information about a current level of skill during a training session and allows training to be stopped when operator reaches the individual baseline profile level. It also enables a system to provide feedback about current operator skill level to the operator himself and to ground control, and also provide information as to why and where the operator is deviating from his/her baseline profile.

In addition to a method of preventing operator skill or performance degradation, according to an embodiment of the present invention a method is also provided to automatically establish a baseline level based on initial training. Currently, it is possible for a learner, or operator, to perform some initial training exercises. The data from those exercises can be analyzed and manipulated with complex mathematical formulae in order to determine a suitable baseline level.

According to a method of automatically establishing a baseline level of the present invention, a desired level (or zone) is created for each parameter corresponding to a level of skill. A training exercise, or set of training exercises, is provided to a learner, in a similar manner as described earlier. The results of the training exercises are monitored until the learner reaches a plateau level, i.e. a level at which the learner's skills have stabilized. The step of monitoring can include a monitoring of the skill acquisition dynamic, with feedback being provided regarding that dynamic. This is similar to the observed skill degradation dynamics, as described earlier. At the point of identifying the plateau level, a baseline level is set for that learner. In the example provided above with respect to robotic manipulation of an object, an example of an identification of a plateau level is three successful consecutive captures, with all criteria being within the desired ranges. Therefore, for this example, the baseline level can automatically be stored in the computer's memory after three successful consecutive captures.

Embodiments of the present invention can be implemented as a computer-readable program product, or part of a computer-readable program product, for use in the system for training an operator to manipulate an object, or other systems and methods according to embodiments of the present invention. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art will appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer-readable program product may be distributed as a removable medium with accompanying printed or electronic documentation (e.g., shrink-wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer-readable program product) and hardware. Still other embodiments of the invention may be implemented as entirely hardware, or entirely software (e.g., a computer-readable program product).

Embodiments of the invention may be implemented in any conventional computer programming language. For example, preferred embodiments may be implemented in a procedural programming language (e.g. “C”) or an object oriented language (e.g. “C++”). Alternative embodiments of the invention may be implemented as pre-programmed hardware elements, other related components, or as a combination of hardware and software components.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A system for training an operator to manipulate an object including an object controller, a display means, and a general purpose computer having a processor and a memory, the system comprising:
a training module for providing a training exercise to the operator in which a simulated object displayed on the display means is to be manipulated by the operator by means of the object controller;
an analysis module for receiving object controller parameters and simulated object parameters, such parameters being gathered during the training exercise;
a presentation module for presenting feedback relating to results of the training exercise to the operator, the feedback being based on both the object controller parameters and the simulated object parameters.

2. The system of claim 1 wherein the object comprises a robotics device to be used in space.

3. The system of claim 1 wherein the system is provided in space or in simulated in-space conditions.

4. The system of claim 1 wherein the presentation module displays graphical data relating to the object controller parameters and the simulated object parameters on the display means.

5. The system of claim 1 wherein the object controller parameters are parameters selected from the group consisting of: position, rate, velocity, orientation, deflection, oscillation, smoothness, accuracy, and speed.

6. The system of claim 1 wherein the analysis module further comprises an evaluation module for evaluating the operator's success in the training exercise and for determining whether further training is needed to achieve a desired skill level stored in the memory.

7. The system of claim 1 wherein the analysis module includes a factor analysis module for determining a factor having a high correlation with the result of the training exercise.

8. The system of claim 7 wherein the presentation module displays graphical data relating to the determined factor.

9. The system of claim 1 wherein the training exercise is customized based on a known operator skill level stored in the memory.

10. The system of claim 1 wherein an individual operator profile associated with each authorized operator is stored in memory and made available to each of the modules.

11. The system of claim 1 wherein the presentation module presents the analysis of results in comparison to a baseline skill level stored in the memory.

12. The system of claim 1 wherein the training exercise is based on critical skills.

13. The system of claim 1 wherein the baseline skill level comprises critical skills determined according to an individual operator profile.

14. The system of claim 1 wherein the object controller comprises a rotational hand controller.

15. The system of claim 1 wherein the object controller comprises a translational hand controller.

16. The system of claim 1 further comprising a transceiver for transmitting information from the presentation module to a receiving station.

17. An autonomous training system for training an operator to manipulate an object, the system comprising:
a general purpose computer having a processor, an object controller and a display means;
a memory means having stored therein baseline skill levels, user profiles, and critical skill training exercises;
a training module for providing a training exercise to the operator in which a simulated object displayed on the display means is to be manipulated by the operator by means of the object controller, the training exercise being selected from the stored critical skill training exercises based on an operator profile retrieved from the stored user profiles;
an analysis module for evaluating, using the processor, the operator's success in the customized training program in comparison to a baseline skill level retrieved from the stored baseline skill levels based on the operator profile;
a presentation module for presenting feedback relating to results of the training exercise to the operator, and for determining whether further training is needed to achieve a desired skill level stored in the memory.

18. The system of claim 17 wherein the analysis module includes means for receiving object controller parameters and simulated object parameters, such parameters being gathered during the training exercise.

19. The system of claim 18 wherein the feedback is based on both the object controller parameters and the simulated object parameters.

20. The system of claim 17 wherein the general purpose computer comprises a graphics computer and a simulation computer and the display means comprises a plurality of video converters in communication with the general purpose computer, and a plurality of video display devices in communication with the plurality of video converters.

21. A method of preventing operator performance degradation for an operator of an object controller, comprising:
providing a training exercise to an operator to improve a degraded operator critical skill;
monitoring recovery dynamics for the degraded operator critical skill during the provided training exercise; and
providing feedback based on the operator's training exercise results.

22. The method of claim 21 further including, before the step of providing the training exercise to the operator, identifying a degraded operator critical skill by comparing a previously observed operator skill level to a baseline skill level.

23. The method of claim 22 wherein the step of identifying a degraded critical operator skill includes identifying the level of degradation.

24. The method of claim 21 wherein the feedback comprises information relating to the monitored recovery dynamics.

25. The method of claim 21 wherein the feedback comprises an identification of an attained skill level based on the operator's training exercise results.

26. The method of claim 21 wherein the feedback comprises a determination of whether further training is needed to achieve a desired skill level.

27. The method of claim 21 wherein the feedback comprises providing detailed analysis of the operator's performance.

28. The method of claim 21 wherein the feedback is provided to the operator.

29. The method of claim 21 wherein the feedback is provided to a central control station.

30. The method of claim 21 wherein the training exercise includes a simulated object and the step of monitoring recovery dynamics for the degraded operator critical skill includes receiving object controller parameters and simulated object parameters, such parameters being gathered during the training exercise.

31. The method of claim 30 wherein the feedback is based on both the object controller parameters and the simulated object parameters.

32. A system for training a learner to accomplish a task including a feedback means, and a general purpose computer having a processor and a memory, the system comprising:
a training module for providing a training exercise to the learner in which a task to be performed is presented to the learner via the feedback means;
an analysis module for receiving parameters relating to the performed task, such parameters being gathered during the training exercise;
a presentation module for presenting feedback via the feedback means relating to results of the training exercise to the operator, the feedback being based on the gathered task-related parameters.

33. A method of automatically establishing a baseline level for a learner training to perform a task, comprising:
providing a set of training exercises to the learner;
monitoring skill acquisition dynamics for the learner during the provided training exercises; and
automatically storing a baseline level in a computer memory after the learner reaches a plateau level based on predetermined criteria.
